(19) United States
(12) Patent Application Publication
(10) Pub. No.: US 2012/0269486 A1
(43) Pub. Date: Oct. 25, 2012

(54) OPTICAL TRANSCEIVER WITH PARTITION WALL DIVIDING A SPACE TO INSTALL CIRCUIT FROM ANOTHER SPACE FOR OPTICAL RECEPTACLE

(76) Inventor: Kuniyuki Ishii, Yokohama-shi (JP)

(21) Appl. No.: 13/514,512

(22) PCT Filed: Dec. 15, 2010
(86) PCT No.: PCT/JP2010/073072

§ 371 Date: Jun. 7, 2012

(51) Int. Cl. G02B 6/42

(52) U.S. Cl. 385/92

(57) ABSTRACT

An optical transceiver disclosed provides an OSA, a circuit board, a housing, a holder and a electrically conductive nonwoven material. The housing provides the first space that provides an optical receptacle and receives an external optical connector, and the second space within which the circuit board is installed. Two spaces are divided by a partition wall with a cut to pass the sleeve of the OSA. The nonwoven material, which is put between the partition wall and the holder, fills a gap formed between the sleeve and the cut.

### TECHNICAL FIELD

The present invention relates to an optical module, in particular, the invention relates to a mechanism in the optical module to shield a space for an electronic circuit from another space for an optical receptacle.

### BACKGROUND ART

One type of optical transceivers has been disclosed in the U.S. Pat. No. 6,085,006. Such an optical transceiver includes an optical sub-assembly (hereafter denoted as OSA), a circuit board, a housing, and a shield. The OSA is electrically coupled in an optical device portion thereof with the circuit board, while a sleeve portion receives an optical ferrule provided in an external connector to couple an external fiber optically with the optical device portion of the OSA. The housing provides two portions, one of which encloses the optical device portion and the circuit board, while, the other installs the sleeve portion. These two spaces are divided in a partition wall, where the sleeve portion passes therethrough. The optical transceiver disclosed in the prior patent installs the shield along the partition wall to shield the former portion from the latter portion. The shield is set within the housing such that the shield abuts against the partition wall as the sleeve portion passes an opening formed in the shield.

The shield may be made of metal sheet. Accordingly, the opening formed therein is necessary to have a diameter greater than a diameter of the sleeve portion to pass it therethrough, which is unavoidable to leave a gap between the shield and the sleeve portion and electro-magnetic radiation may be leaked from the gap. As the operation speed of the optical transceiver becomes faster, the gap with relatively smaller width becomes a subject of the leaking of the electro-magnetic radiation.

### SUMMARY OF THE INVENTION

An optical module according to one aspect of the present invention comprises an OSA, a circuit board, an electrically conductive housing, and a nonwoven material. The OSA may include a sleeve and an optical device. The circuit board may be electrically connected to the optical device. The housing may include a first space for installing the optical device and the circuit board, a second space for installing the sleeve and a partition wall for dividing the second space from the first space and providing a cut through which the sleeve passes. One feature of the optical module according to the present invention is that, the nonwoven material may be made of electrically conductive material and come in contact with the partition wall and the sleeve so as to fill the gap formed between the sleeve and the cut in the partition wall.

The optical module of the present invention may further comprise a holder with an opening to pass the sleeve therethrough and may be put between the nonwoven material and a flange of the sleeve. That is, the nonwoven material may be put between the partition wall and the holder and come in contact with the holder in a surface. The opening in the holder may include first to third bores. The first bore receives the sleeve, the second bore has a diameter greater than a diameter of the first bore and supports the flange of the sleeve, and the third bore has a diameter less than the diameter of the flange. Accordingly, the third bore may form a space to receive a portion of the nonwoven material deformed between the partition wall and the holder.

The housing of the present invention may include a bottom housing and a top housing, wherein the top housing provides the partition wall, while, the bottom housing provides an elastic member with electrically conductive characteristic along a periphery of the second space of the housing, wherein the elastic member may come in contact with the top of the partition wall and also in contact with the nonwoven material. Thus, because the nonwoven material may fill the gap between the holder and the sleeve, and come in contact with the bottom housing, the second space of the housing may be effectively shielded from the first space even the sleeve passes the partition wall. The nonwoven material may be a type of nonwoven fabric, in particular, the nonwoven material may be made of polyethylene terephthalate coated or plated with copper or nickel.

### BRIEF DESCRIPTION OF DRAWINGS

The foregoing and other purposes, aspects and advantages will be better understood from the following detailed description of a preferred embodiment of the invention with reference to the drawings, in which:

FIG. 1 is an exploded view of an optical transceiver according to an embodiment of the present invention;

FIG. 2 is a perspective view showing a bottom housing of the optical transceiver shown in FIG. 1;

FIG. 3 is a perspective view showing a top housing of the optical transceiver shown in FIG. 1;

FIG. 4 is a perspective view showing an intermediate assembly of the OSA, the holder, and the nonwoven material;

FIG. 5 is an exploded view of the intermediate assembly shown in FIG. 4;

FIG. 6 is a perspective view of the intermediate assembly, a part of which is broken to show an assembling condition;

FIG. 7 is a cross section of the assembly taken along the line VII-VII shown in FIG. 4; and

FIG. 8 is a perspective view that magnifies a front portion of the optical transceiver as omitting the top housing thereof.

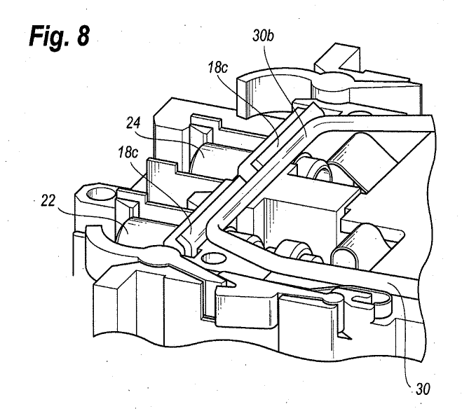

### DESCRIPTION OF EMBODIMENTS

Next, some preferred embodiments according to the present invention will be described as referring to to accompanying drawings. In the description of the drawings, the same or the like elements will be referred by the same or the like numerals or the symbols without overlapping explanations.

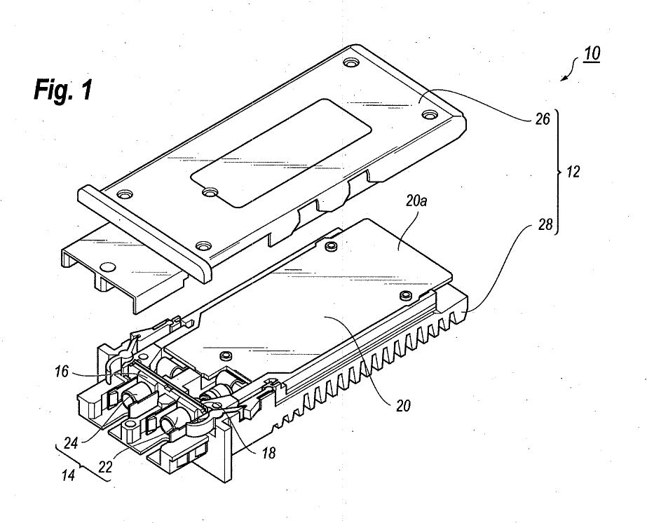

FIG. 1 is a perspective view showing an optical module according to an embodiment of the present invention. The optical module 10 shown in FIG. 1 primarily comprises a housing 12, an optical sub-assembly (hereafter denoted as OSA) 14, a holder 16, a nonwoven material 18, and a circuit board 20. The optical module 10 includes, as the optical sub-assembly 14, a transmitter optical sub-assembly (hereafter denoted as TOSA) 14 and a receiver optical sub-assembly (hereafter denoted as ROSA) 24; hence, the optical module 10 may be called as an optical transceiver which permits the full-duplex optical communication.

Respective components in the optical transceiver 10 will be described. In the description below, a front side corresponds to a portion where the optical sub-assembly 14 is installed, while, a rear side corresponds to the opposite thereto. Further, a longitudinal direction of the optical transceiver means the direction from the front to the rear, while, the lateral direction means the direction perpendicular thereto, and the up-and-down direction is rest direction perpendicular to both the longitudinal and lateral directions.

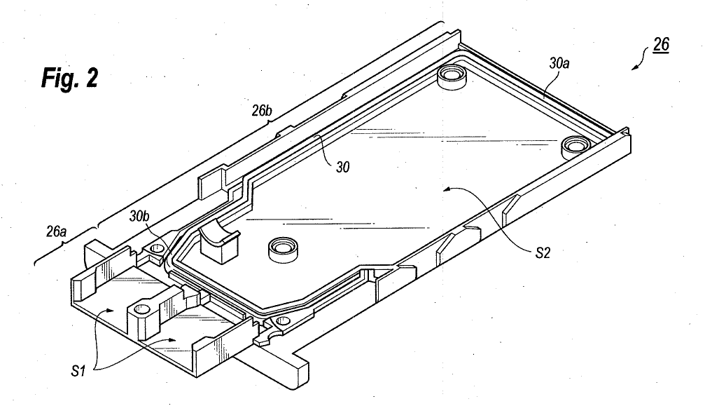

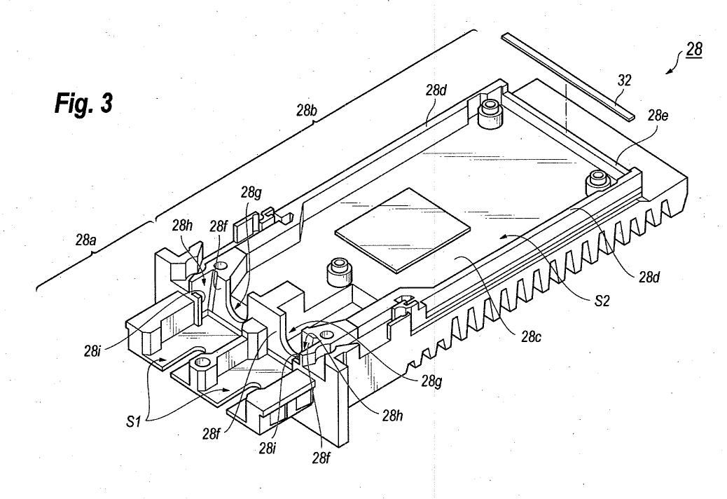

The housing 12 encloses the OSA 14, the holder 16, the nonwoven material 18, and the circuit board 20 therein, and includes the bottom housing 26 and the top housing 28. FIG. 2 shows the inside of the bottom housing 26, while, FIG. 3 shows the inside of the top housing 28. The bottom housing 26 is made of electrically conductive material, typically formed by the die-casting of zinc (Zn). The bottom housing 26 includes a first portion 26a and a second portion 26b from the front side of the optical transceiver 10.

The first portion 26a forms the first space S1 accompanied with the first portion in the top housing 28, which is described later. The first space S1 provides a space where the optical sub-assembly 14 optically couples with an external optical connector by setting the sleeve of the optical sub-assembly 14 in a rear portion of the first space S1. The external optical connector is set within the first space S1 from the front end thereof.

In the present embodiment shown in FIG. 2, the first space S1 is divided into two areas by a center partition, one of which is for the TOSA 22, while the other is for the ROSA 24. Thus, the first portion 26a provides a ceiling of the first space S1 to constitute a portion of the optical receptacle.

The second portion 26b forms the second space S2 cooperating with the second portion of the top housing 28, which will be also described later. The second space S2 installs the circuit board 20 and a rear portion of the OSA 14 where a semiconductor optical device is enclosed. The second portion 26b provides a ceiling for the second space S2.

A groove is formed in the edge surrounding the second space S2, within which an elastic member 30 with an electrically conductive characteristic is set. The elastic member 30, which may be made of silicone or graphite, may enhance the shielding performance of the second space S2.

The top housing 28 also has an electrically conductive characteristic, and may be made of, for instance, die-casting of zinc. FIG. 3 illustrates the inside of the top housing 28. As shown in FIG. 3, the top housing 28 includes the first portion 28a and the second portion 28b from the front of the optical transceiver 10. The first portion 28a provides a bottom of the first space S1, while, the second portion 28b provides a bottom of the second space S2.

The second space 28b includes a pair of side walls 28d and a rear wall 28c. The side walls 28d rise substantially at right angles from respective edges in the lateral direction and the rear wall also rises substantially at right angles from the rear edge. The height of the rear wall is less than a height of the side walls to set a nonwoven material 32 on the top thereof. The nonwoven material shows electrically conductive characteristic and may be made of, for instance, polyethylene terephthalate fiber coated with nickel (Ni) or copper (Cu). An electrically conductive adhesive may stick the nonwoven material 32 on the top of the rear wall 28e.

The nonwoven material 32 set on the top of the rear wall 28e faces a rear portion 30a of the elastic member 30 set within the groove of the bottom housing 26. The rear wall 28e of the top housing 28 forms a gap with respect to a portion of the bottom housing 26 facing the rear wall 28e to protrude the electrical plug 20a of the circuit board 20 outwardly. The electrical plug 20a may electrically couple the optical transceiver 10 with the host system. The nonwoven material 32 and the rear portion 30a of the elastic member 30 come in closely contact with the top and back surfaces of the circuit board 20, respectively, when the top and top housings, 26 and 28, are assembled with, which may enhance the shielding performance of the second space S2. The circuit board 20 may provide a ground pattern in a portion coming in contact with the nonwoven material 32 or the rear 30a of the elastic member 30, which may provide a stable frame ground on the circuit board 20.

The top housing 28 provides a partition wall 28f that distinguishes the second space S2 from the first space S1. The partition wall 28f laterally extends and provides two cuts, 28g and 28h, with a U-shape.

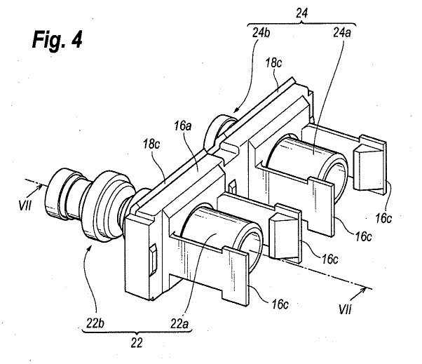

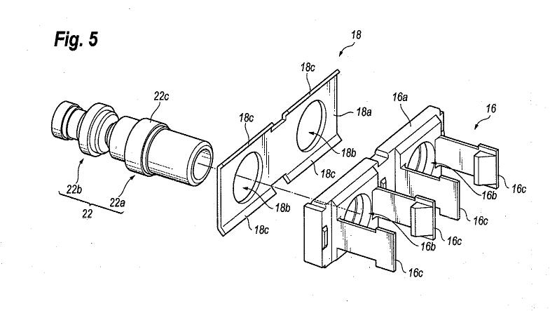

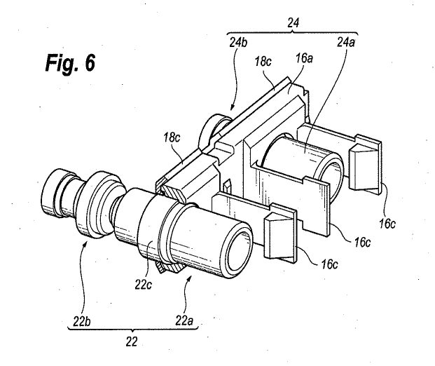

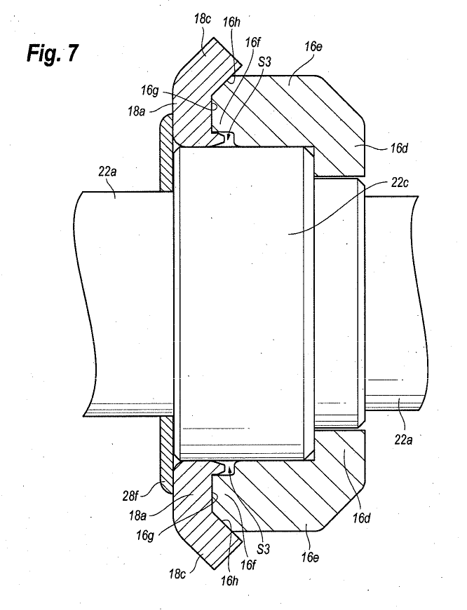

Next, respective components installed within the housing 12 will be described in further detail as referring to FIGS. 4 to 7, where FIG. 4 shows an intermediate assembly of the OSA 22, the holder 16 and the nonwoven material 18, FIG. 5 is an exploded view of the intermediate assembly shown in FIG. 4, FIG. 6 is a perspective view of the intermediate assembly but a portion of the holder 16 and the nonwoven material 18 are removed, and FIG. 7 is a cross section of the intermediate assembly taken along the line VII-VII shown in FIG. 4.

The TOSA 22 includes the sleeve 22a and the optical device 22b. The sleeve 22a, which has a cylindrical shape, may optically couple an external optical fiber secured in the external optical connector with a semiconductor optical device installed in the optical device 22b by receiving a ferrule provided in the external optical connector within a bore thereof. The sleeve 22a includes a flange 22c in the outer periphery thereof, which is shown in FIG. 5.

The optical device 22b includes an LD as the semiconductor optical device, and a package with a case and lead pins. The lead pins are electrically connected with a circuit on the circuit board by, for instance, a flexible printed circuit board. The ROSA 24 has a substantially same arrangement with that of the TOSA 22 but the optical device 24b thereof includes a photodiode as the semiconductor optical device to receive light from the external fiber.

The TOSA 22 and the ROSA 24 are supported by the holder 16. The holder 16 includes a primary body 16a with two openings 16b through which the sleeve, 22a and 24a, pass. Each opening 16b accompanies with a pair of hooks 16c in both sides thereof to latch the external optical connector therewith.

As illustrated in FIG. 7, the primary body 16a includes first to third portions, 16d to 16f, from the front to the rear in this order. These three portions, 16d to 16f, form the opening 16b. The first portion 16d provides an opening whose diameter is less than that of the flange 22c and abuts against the front surface of the flange 22c. The second portion 16e has an opening whose diameter is substantially identical with that of the flange 22c; thus, the second portion 16e supports the flange 22c. The third portion 16f has an opening whose diameter is greater than the diameter of the opening in the second portion 16e. The third portion 16f makes a ringed gap S3 against the flange 22c in the rear end of the holder 16. Although FIG. 6 illustrates the arrangement of the holder 16 for the TOSA 22, the ROSA 24 may have the same physical arrangement with those of the TOSA 22 shown in FIG. 6. The openings in three portions, 16d to 16e, constitute concentric openings whose center axes are identical to each other.

The primary body 16a of the holder 16 provides two walls, 16g and 16h, as the rear surface thereof. The former wall 16g is substantially perpendicular to the axis of the opening 16b, while, the latter wall 16h is chamfered wall inclined to the former wall 16g. These two walls, 16g and 16h, support the nonwoven material 18.

As described above, the nonwoven material is electrically conductive and made of polyethylene terephthalate coated or plated with copper or nickel. The electrically conductive adhesive may stick the nonwoven material 18 on the walls, 16g and 16h. The nonwoven material 18 includes the first and second portions, 18a and 18c, respectively, the former of which traces the first wall 16g, while, the latter is stuck on the second wall 16h.

The first portion 18a includes two openings 18b each continuous to respective openings 16b in the holder 16 and passes the sleeve, 22a and 24a, of the OSA therethrough. The nonwoven material 18 covers the cylindrical outer surface of the TOSA 22 and that of the ROSA 24. Thus, the diameter 18 of the opening 18b in the nonwoven material 18 may be set in a state free from the OSA, that is, before inserting the sleeve, 22a and 24a, to be less than the diameter of the flange, 22c and 24c.

In order to make the nonwoven material 18 in closely contact to the outer surface of the sleeve, 22a and 24a, without leaving any gap, the diameter of the opening 18b may be smaller than the outer diameter of the flange, 22c and 24c, at the initial condition thereof. In such a case, the nonwoven material 18 is deformed as the sleeve, 22a and 24a, is inserted into the opening 18b, but the gap S3 between the flange, 22c and 24c, and the third portion 16f of the holder 16 may receive a deformed portion of the nonwoven material 18.

An intermediate assembly of the OSA 14, the holder 16, the nonwoven material 18 and the circuit board 20 are installed within the housing 12. The top housing 28 provides a groove 28h in both sides of the first portion 28a thereof, where the groove 28h vertically extends, as shown in FIG. 3. This groove 28i may be constituted by the wall 28i and the partition wall 28 facing to each other. A distance between the walls, 28f and 28i, may be slightly smaller than a total thickness of the nonwoven material 18 and a thickness of the primary body 16a of the holder 16. Accordingly, setting the intermediate assembly within the housing 12, the wall 28i pushes the primary body 16a of the holder rearward, the wall 16g of the primary body 16a compresses the nonwoven material 18 and abuts it against the partition wall 28f. Thus, the nonwoven material 18 may come in contact with the partition wall 28f in a wide area, and the gap between the OSA 14 and the partition wall 28f may be filled with the nonwoven material 18, which may electrically shield the second portion S2 from the first portion S1.

Moreover, a front portion 30b of the elastic member 30 passes on a top of the partition wall 28f. This front portion 30b, which is put between the partition wall 28f of the top housing 28 and the bottom housing 26, may come in contact with a top of the second portion 18c of the nonwoven material 18, which may further shield the second portion S2 from the first portion S1.

Although the present invention has been fully described in conjunction with the preferred embodiment thereof with reference to the accompanying drawings, it is to be understood that various changes and modifications may be apparent to those skilled in the art. For instance, the optical transceiver may provide only one of the TOSA and the ROSA, which is called merely as an optical module. Such changes and modifications are to be understood as included within the scope of the present invention as defined by the appended claims, unless they depart therefrom.

1. An optical module, comprising:
an optical sub-assembly including a sleeve and an optical device;
a circuit board electrically connected with said optical device;
a housing including a first space, a second space and a partition wall, said first space installs said sleeve, said second space installs said optical device and said circuit board, said partition wall dividing said second space from said first space and providing a cut through which said sleeve passes; and
a nonwoven material made of electrically conductive material, said nonwoven material coming in contact with said partition wall and said sleeve, wherein said nonwoven material fills a gap formed between said sleeve and said cut in said partition wall.

2. The optical module of claim 1,
further comprising a holder with an opening to pass said sleeve therethrough,
wherein said holder is put between said nonwoven material and a flange provided in said sleeve.

3. The optical module of claim 2,
wherein said opening in said holder includes first to third bores, said first bore receiving said sleeve, said second bore having a diameter greater than a diameter of said first bore and supporting said flange, said third bore having a diameter less than said diameter of said flange,
wherein said third bore forms a space to receive a portion of said nonwoven material deformed between said partition wall and said holder.

4. The optical module of claim 2,
wherein said nonwoven material comes in contact with said holder in a surface.

5. The optical module of claim 1,
wherein said housing includes a bottom housing and a top housing, said top housing providing said partition wall, said bottom housing providing an elastic member with electrically conductive characteristic along a periphery of said second space of said housing,
wherein said elastic member comes in contact with a top of said partition wall.

6. The optical module of claim 5,
wherein said elastic member comes in contact with said nonwoven material.

7. The optical module of claim 5,
wherein said top housing provides a groove in a side wall thereof,
wherein said groove has a width less than a total thickness of said nonwoven material and said holder where said nonwoven material and said holder are not installed in said optical module.

8. The optical module of claim 7,
wherein said nonwoven material is compressed between said holder and said partition wall.

9. The optical module of claim 1,
wherein said nonwoven material is a nonwoven fabric.

10. The optical module of claim 9,
wherein said nonwoven fabric is made of polyethylene terephthalate processed by at least one of coating and plating with copper or nickel.
